(19) United States
(12) Patent Application Publication
(10) Pub. No.: US 2011/0073239 A1
(43) Pub. Date: Mar. 31, 2011

(54) METHOD OF MAKING RECYCLED ENERGY ABSORBING UNDERLAYMENT AND MOISTURE BARRIER FOR HARD FLOORING SYSTEM

(75) Inventors: Norman Manning, Hendersonville, TN (US); Steven E. Ogle, Murfreesboro, TN (US)

(73) Assignee: L & P PROPERTY MANAGEMENT COMPANY, Southgate, CA (US)

(21) Appl. No.: 12/959,117

(22) Filed: Dec. 2, 2010

Related U.S. Application Data
(63) Continuation of application No. 11/291,633, filed on Dec. 1, 2005.
(60) Provisional application No. 60/632,315, filed on Dec. 1, 2004.

(51) Int. Cl. B32B 37/02

(52) U.S. Cl. 156/62.2; 156/60; 156/92

(57) ABSTRACT

A flooring underlayment comprising a plurality of recycled fibers formed into a nonwoven fiber batt, and a resin intermixed with the recycled fibers in the nonwoven fiber batt, the resin bonding the recycled fibers together. The invention includes a flooring underlayment comprising a plurality of recycled fibers formed into a nonwoven fiber batt, wherein the nonwoven fiber batt is formed using a method selected from the group comprising resin bonding, thermal bonding, mechanical bonding, and combinations thereof. The invention includes a nonwoven fiber batt comprising a blend of recycled fibers and binder fibers formed into a nonwoven fiber batt, and a resin intermixed with the recycled fibers and the binder fibers in the nonwoven fiber batt, wherein the resin and the binder fibers bond the recycled fibers and the binder fibers in the nonwoven fiber bait together.

### CROSS-REFERENCE TO RELATED APPLICATIONS

This application is a continuation of and claims benefit under 35 USC §120 to co-pending U.S. patent application Ser. No. 11/291,633 entitled “Recycled Energy Absorbing Underlayment and Moisture Barrier for Hard Flooring System” filed Dec. 1, 2005, which in turn, was related to and claims benefit under 35 USC §119 to U.S. Provisional Patent Application Ser. No. 60/632,315 filed Dec. 1, 2004, all of Which are assigned to the Assignee of the present application and hereby incorporated by reference as if reproduced in their entirety.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure relates to flooring systems and, more particularly, to a hard flooring system that contains an energy absorbing layer manufactured from recycled materials and a moisture barrier.

### BACKGROUND

Typically, a subfloor is either a slab of concrete or one or more sheets of plywood supported by a combination of joists, beams, posts and, in multiple-story buildings, bearing walls. Broadly speaking, a flooring layer is comprised of the various materials which, when installed above the subfloor, collectively form the flooring for a building or other structure. Many times, an underlayment may be installed between the subfloor and the flooring layer. The primary types of flooring layers used in structures are “soft” flooring layers and “hard” flooring layers. As its name suggests, soft flooring is soft, quiet underfoot, and tends to yield upon application of a force thereto. Hard flooring, on the other hand, is hard and thus durable and easy to maintain. However, hard flooring also tends to be relatively noisy, cold, and hard underfoot.

Most hard flooring, particularly wood and laminate flooring, has an underlayment installed between the subfloor and the flooring, which acts as a moisture barrier, an energy absorber, and a leveler. Moisture barriers are important because they prevent the migration of moisture from the subfloor into the flooring. Moisture barriers are essential for slab foundations and basements because the moisture frequently seeps through the concrete subfloor into the wood or laminate flooring, causing the wood to warp or the laminate flooring to delaminate. If the flooring is soft flooring, such as carpet, moisture causes mildew or microbial growth in the carpet. Underlayment is also important in hard flooring because the underlayment absorbs some of the sound or “echo” created by a person walking on the hard floor. Underlayment also creates a more level surface for the flooring by smoothing high points (peaks), low points (valleys), and other irregularities in the subfloor so that the flooring rests on a more level surface.

A wide variety of underlayments are used in conjunction with flooring. For example, a thin, continuous film of polymer, such as polyethylene or vinyl, may be installed over the subfloor to provide a moisture barrier. Oftentimes, a polymeric open cell foam layer is positioned over the polymer film to provide a degree of cushioning to the flooring placed above it. The polymer film and open cell foam layer may be laminated to one another or may be discrete components installed one over the other. Alternatively, a solid sheet of polymer having some cushioning characteristics, for example, a slightly polymerized vinyl chloride polymer, can function as both a moisture barrier and a cushion between the subfloor and the flooring. Another suitable underlayment is a laminate composite formed of a moisture impervious vinyl, polyethylene, or polyester film attached to latex or vinyl foam. Other flooring underlayments include nonwoven batts of polyester, nylon, or polypropylene with a moisture harrier attached to one side of the batt.

One of the goals of flooring manufacturers is to reduce the time and complexity of installing the flooring. While this goal is important for flooring that is installed by professional installers, such as carpet, this goal is essential for flooring that is installed by consumers, such as laminate flooring, because consumers will often base their purchase decisions on the complexity and time required to install the flooring as well as the price of the flooring. These consumer needs have led to an increase in the number of flooring systems that have tongue-and-groove, click-together, or other connection mechanisms on a plurality of their edges so that the flooring is quick and easy to install. However, with all of these advances in flooring installation, the consumer still has to install the underlayment in the conventional manner, which often includes laying down sheets of the underlayment on the subfloor prior to installing the flooring. Therefore, a need exists for a method of simplifying the process of installing a flooring underlayment while simultaneously reducing the time required to install the underlayment.

One of the ongoing concerns of many underlayment manufacturers is the need to reduce manufacturing costs. Lowered manufacturing costs result in lower product costs, which make the manufactured product more appealing to the consumers. Underlayment consumers, particularly large retail outlets and flooring installers, are constantly seeking the lowest price on flooring underlayment and frequently change suppliers in order to save a few cents per square foot of underlayment. Thus, it is in the manufacturers' best interest to produce flooring underlayment for the lowest possible price. As the cost of upgrading manufacturing equipment to improve efficiency can be prohibitive, most manufacturers seek to lower production costs by using less expensive materials to manufacture the underlayment. Consequently, what is needed is a flooring underlayment material that is less expensive than the existing flooring underlayment material, which will allow manufacturers to produce and sell a flooring underlayment that is less expensive than existing flooring underlayment.

Another ongoing concern for many manufacturers is the consumer's perception of the manufacturer. Manufacturers who use recycled materials to manufacture their product are perceived as environmentally friendly or “green”, a trait preferred by consumers who are environmentally conscious. Consumers who are environmentally conscious are willing to pay a premium for goods that contain recycled materials. Recycled materials are generally made from previously used or waste materials, and thus are relatively inexpensive. Because recycled materials are both cost-effective and consumer-preferable, a need exists for a flooring underlayment that utilizes recycled materials.

### SUMMARY

In one aspect, the invention includes a flooring underlayment comprising: a plurality of recycled fibers formed into a nonwoven fiber batt; and a resin intermixed with the recycled fibers in the nonwoven fiber batt, the resin bonding the recycled fibers together. In an embodiment, the recycled fibers are shoddy fibers. In another embodiment, the flooring underlayment comprises an upper surface and a lower surface; and the flooring underlayment further comprises a moisture barrier attached to the upper surface or the lower surface of the nonwoven fiber batt. The moisture barrier may comprise a flap that extends past the edge of the nonwoven fiber batt and/or the moisture barrier may be closed cell foam. In yet another embodiment, the nonwoven fiber batt has a ratio of basis weight to thickness greater than about 2 to 1. The moisture barrier may be attached to the nonwoven fiber batt without an adhesive. Variously, the nonwoven fiber batt has a density at most about 10 pounds per cubic foot, and/or the flooring underlayment is attached to a flooring layer. The invention includes a flooring system comprising: a subfloor; a flooring layer positioned above the subfloor; and the flooring underlayment positioned between the subfloor and the flooring layer.

In another aspect, the invention includes a flooring underlayment comprising a plurality of recycled fibers formed into a nonwoven fiber batt, wherein the nonwoven fiber batt is formed using a method selected from the group comprising: resin bonding, thermal bonding, mechanical bonding, and combinations thereof. In an embodiment, the flooring underlayment comprises an upper surface and a lower surface and the flooring underlayment further comprises a moisture barrier attached to the upper surface or the lower surface of the nonwoven fiber batt. In another embodiment, the nonwoven fiber batt has a density at most about 10 pounds per cubic foot. The recycled fibers may be shoddy fibers. The invention includes a flooring system comprising: a subfloor; a flooring layer positioned above the subfloor; and the flooring underlayment positioned between the subfloor and the flooring layer.

In yet another aspect, the invention includes a nonwoven fiber batt comprising: a blend of recycled fibers and binder fibers formed into a nonwoven fiber batt; and a resin intermixed with the recycled fibers and the binder fibers in the nonwoven fiber batt; wherein the resin and the binder fibers bond the recycled fibers and the binder fibers in the nonwoven fiber batt together. In an embodiment, the nonwoven fiber batt comprises an upper surface and a lower surface; and the nonwoven fiber batt further comprises a moisture barrier attached to the upper surface or the lower surface of the nonwoven fiber batt. Variously, the nonwoven fiber batt has a density at most about 10 pounds per cubic foot, and/or the binder fibers have a weight per unit length at most about 5 denier. The invention includes a flooring system comprising: a subfloor; a flooring layer positioned above the subfloor; and the nonwoven fiber bait of claim 16 positioned between the subfloor and the flooring layer.

### BRIEF DESCRIPTION OF THE DRAWINGS

For a more complete understanding of the present invention, and for further details and advantages thereof, reference is now made to the accompanying drawings, in which:

FIG. 1 is a perspective view of an embodiment of the Recycled Energy Absorbing Underlayment and Moisture Barrier for Hard Flooring System;

FIG. 2 is a perspective view an embodiment of the Recycled Energy Absorbing Underlayment and Moisture Barrier for Hard Flooring System installed under the hard flooring layer;

FIG. 3 is a perspective view of an embodiment of the Recycled Energy Absorbing Underlayment and Moisture Barrier for Hard Flooring System attached to the hard flooring layer;

FIG. 4 is a block diagram of an embodiment of the method of manufacturing the fiber batt embodiment of the Recycled Energy Absorbing Underlayment and Moisture Barrier for Hard Flooring System;

FIG. 5 is a plan view of an embodiment of an apparatus for manufacturing the fiber batt embodiment of the Recycled Energy Absorbing Underlayment and Moisture Barrier for Hard Flooring System in accordance with the method of FIG. 4;

FIG. 6A is a side view of an embodiment of a thermal bonding apparatus used in forming the shoddy batt embodiment of the Recycled Energy Absorbing Underlayment and Moisture Barrier for Hard Flooring System in accordance with the method of FIG. 4;

FIG. 6B is a side view of an embodiment of an alternative thermal bonding apparatus used in forming the shoddy batt embodiment of the Recycled Energy Absorbing Underlayment and Moisture Barrier for Hard Flooring System in accordance with the method of FIG. 4;

FIG. 7 is a block diagram of an embodiment of the method of manufacturing the bonded foam embodiment of the Recycled Energy Absorbing Underlayment and Moisture Barrier for Hard Flooring System;

FIG. 8 is a side view of an embodiment of a mixing tank used in forming the bonded foam embodiment of the Recycled Energy Absorbing Underlayment and Moisture Barrier for Hard Flooring System;

FIG. 9 is a side view of an embodiment of an apparatus for compressing and steaming the bonded foam embodiment of the Recycled Energy Absorbing Underlayment and Moisture Barrier for Hard Flooring System;

FIG. 10 is a side view of an embodiment of an apparatus for peeling the bonded foam embodiment of the Recycled Energy Absorbing Underlayment and Moisture Barrier for Hard Flooring System;

FIG. 11 is a side view of an embodiment of an alternative apparatus for compressing and steaming the bonded foam embodiment of the Recycled Energy Absorbing Underlayment and Moisture Barrier for Hard Flooring System;

FIG. 12 is a side view of an embodiment of an apparatus for laminating the film embodiment of the moisture barrier onto the energy absorbing layer in accordance with the methods of FIGS. 4 and 7; and

FIG. 13 is a side view of an embodiment of the apparatus for laminating the closed cell foam embodiment of the moisture barrier onto the energy absorbing layer in accordance with the methods of FIGS. 4 and 7.

### DETAILED DESCRIPTION

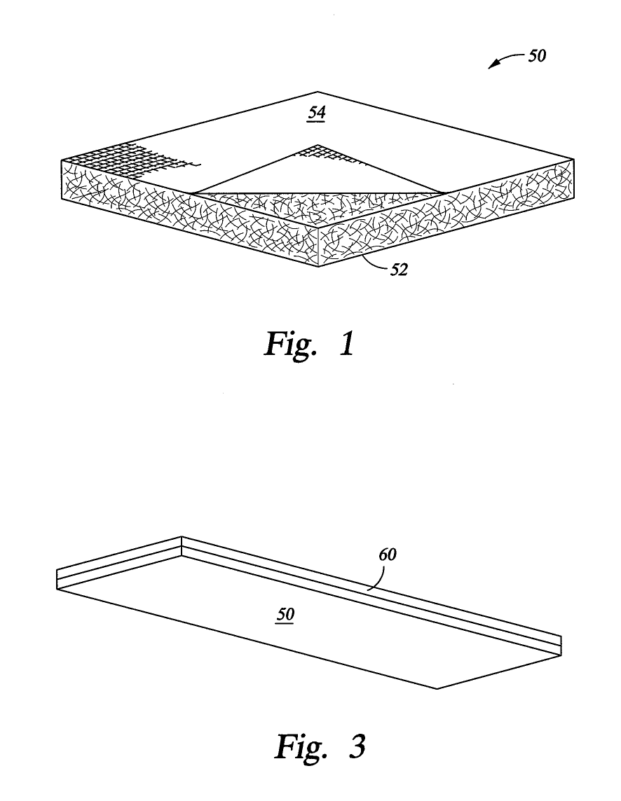

The Recycled Energy Absorbing Underlayment and Moisture Barrier for Hard Flooring System will now be described in greater detail. As seen in FIG. 1, the underlayment 50 generally comprises a moisture barrier 54 laminated onto an energy absorbing layer 52 made of recycled materials. The energy absorbing layer 52 may be a nonwoven fiber batt made from recycled fibers, such as shoddy materials or bonded foam. Shoddy materials are recycled fibers from clothing, bedding, fabric, and other natural and synthetic materials. Alternatively, the shoddy materials may be a specific type of recycled fiber, such as polyester or polypropylene from the manufacturing of bedding components or cotton waste from the yarn spinning process. The shoddy material is generally cleaned and shredded to form a homogeneous blend of fibers prior to being formed into a nonwoven batt. Bonded foam pads are made from a plurality of foam pieces that are attached together. The foam pieces are generally collected from waste, trimmings, and recycled carpet pads. The foam pieces are preferably polyurethane foam, but may also be other materials such as latex foam, polyvinyl chloride (PVC) foam, or any other polymeric foam.

The moisture barrier 54 is a thin layer of material that is attached or otherwise laminated onto the energy absorbing layer 52. The moisture barrier 54 is made of a material that is impervious to liquid moisture and moisture vapor. Alternatively, the moisture barrier 54 may be permeable with respect to moisture vapor, but impervious to liquid moisture. Such moisture barriers 54 are advantageous because they discourage the transmission of liquid moisture across the underlayment yet allow the underlayment to “breathe.” Further in the alternative, the moisture barrier 54 may contain one hydrophobic side and one hydrophilic side. Such moisture barriers 54 encourage the migration of moisture in one direction, but not the other direction. The moisture barrier 54 is typically a polymeric film, such as polyethylene or ethylene vinyl acetate (EVA) copolymer. An example of a suitable film is 150 gauge low density polyethylene film weighing 35 grams per square meter, available from numerous manufacturers including Dow® and DuPont®. Alternatively, the moisture barrier 54 may be a layer of closed cell foam, such as a styrene butadiene rubber (SBR), latex, or PVC foam. By definition, closed cell foam has too few interconnecting cells to allow the transmission of bulk fluids through the foam. The formulation of a typical closed cell foam is disclosed in U.S. patent application Ser. No. 10/306,271 to Brodeur et al., entitled “Moisture Barrier and Energy Absorbing Cushion,” incorporated herein by reference as if reproduced in its entirety. A number of other moisture barriers 54 are commercially available, any one of which may be suitable for the underlayment 50.

While the underlayment 50 is described in conjunction with hard flooring layer, it is contemplated that the underlayment 50 can be used as an underlayment for any type of flooring. As used herein, the term “flooring” refers to any type of flooring product that utilizes an underlayment. The term flooring includes soft flooring, such as carpet and rugs, and hard flooring. As used herein, the term “hard flooring” refers to rigid flooring products that utilize and underlayment such as ceramic tile, linoleum, vinyl, wood flooring, and laminate flooring. Hard flooring layers typically require an underlayment with a moisture barrier that keeps moisture from migrating from the subfloor into the hard flooring layer. Moisture in the hard flooring layer is not preferred because the moisture tends to warp, rot, or delaminate the hard flooring. As used herein, the term “laminate flooring” describes any flooring product that contains various layers attached or otherwise laminated together and includes laminated pressboard, paper, or wood particles, and the like. The term “laminate flooring” also includes ceramic tile or other flooring attached to laminated pressboard, paper, or wood particles, and the like. Examples of laminate flooring are the products sold under the names PERGO™ laminate flooring and EDGE™ precision tile.

The orientation of the underlayment (i.e. with the moisture barrier on the upper or lower side of the energy absorbing layer) when installed under the hard flooring layer is an important aspect of installing the underlayment. For example, if the underlayment is placed moisture barrier side down, then the moisture barrier prevents the migration of moisture from the subfloor into the energy absorbing layer and the hard flooring layer. This application is typically well suited for basement and slab foundation applications. Alternatively, if the underlayment is placed moisture barrier side up, the moisture barrier prevents the migration of moisture from the hard flooring layer into the energy absorbing layer. This application is typically well suited for upper floor applications. However, the circumstances associated with individual applications will dictate the particular orientation of the underlayment (i.e. whether the moisture barrier side is placed face-up or face-down) when the underlayment is installed under the flooring.

In an alternative embodiment, the underlayment can be configured with the moisture barrier on both sides of the energy absorbing layer. This embodiment enjoys the benefits of both embodiments described above: a moisture barrier between the subfloor and the energy absorbing layer, and a moisture barrier between the energy absorbing layer and the hard flooring layer. This embodiment is preferable when the energy absorbing layer has a high percentage of absorbent materials because the absorbent materials readily absorb moisture into the energy absorbing layer and can promote the growth of mildew, mold, fungus, and/or microbes. It is also contemplated the underlayment can contain an antimicrobial additive to discourage the growth of mildew, mold, fungus, and microbes. Two examples of such antimicrobial, antifungal, or similar additives are the Sanitized™ and Actigard™ product lines available from Sanitized AG of Burgdorf, Switzerland. The incorporation of an antimicrobial, antifungal, or similar additive to the underlayment is described in U.S. patent application Ser. No. 10/840,309 to Gilder entitled “Anti-Microbial Carpet Underlay and Method of Making”, which is incorporated herein by reference as if reproduced in its entirety.

As a further alternative embodiment, the underlayment can be configured without a moisture barrier laminated onto the energy absorbing layer. Manufacturing the energy absorbing layer without a moisture barrier lowers the production cost of the underlayment. The moisture barrier may be unnecessary for applications where discouraging moisture migration is not an issue. In dry climates, such as the southwest United States, moisture is not as problematic as in coastal and other humid regions. Thus, the need for a moisture barrier is not as great in these areas. In addition, multi-story homes may not need a moisture barrier on the upper floors because moisture migration from the subfloor is limited to the bottom floor of the residence. Thus, there may not be a need for a moisture barrier on the upper floors. Consequently, in some applications the elimination of the moisture barrier from the manufacturing process can reduce the production costs and make the underlayment less expensive and thus more appealing to consumers.

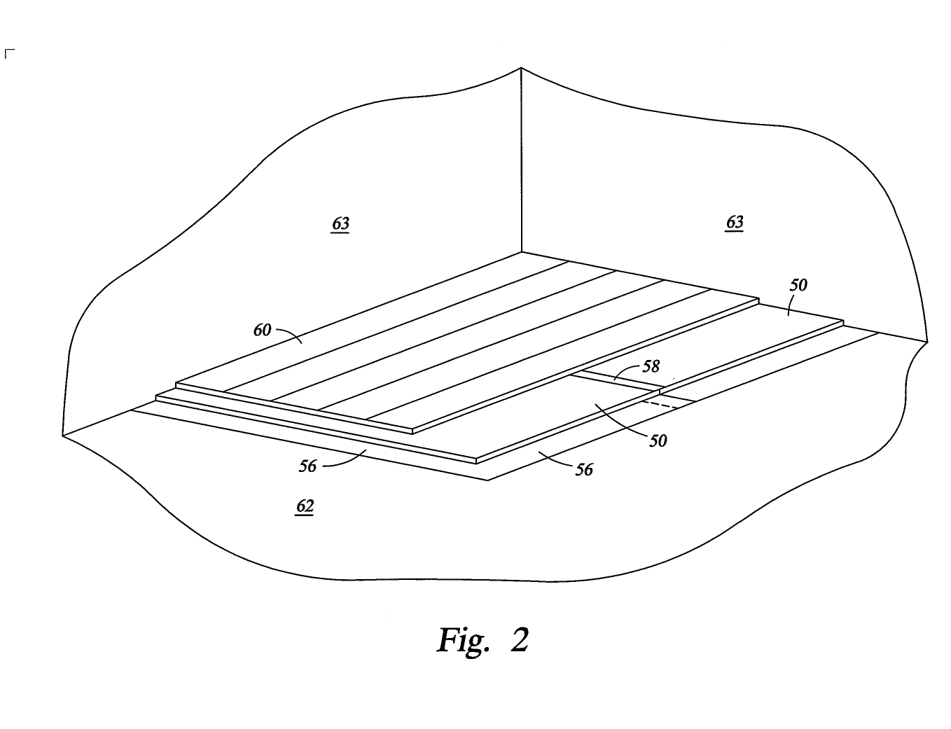

In a further alternative embodiment, the underlayment can be manufactured with a flap that is an extension of the moisture barrier past at least one edge of the underlayment (see flap 56 in FIG. 2). Preferably, the flap consists of about 4 inches of moisture barrier extending past two adjacent edges of the underlayment. This embodiment allows the flap of a previously installed piece of underlayment to be positioned underneath the moisture barrier on a newly installed and similarly oriented piece of underlayment, thereby creating an overlapping moisture barrier at the seam between the two pieces of underlayment. The overlapping moisture barrier is beneficial because there is an opportunity for moisture to circumvent the moisture barrier at the seam between two pieces of underlayment. An overlapping moisture barrier is additional assurance that the moisture barrier will discourage the migration of moisture into the flooring. If the moisture barrier is on the upper surface of the underlayment, the flap may be secured in place with tape. If the moisture barrier is on the lower surface of the underlayment, the weight of the newly installed piece of underlay is sufficient to hold the flap in place. However, the newly installed piece of underlayment can be secured to the existing piece of underlayment with a piece of tape or other apparatus, if desired.

The installation of the underlayment will now be described in greater detail. FIG. 2 is a perspective view of a corner of a room where the underlayment 50 is installed between the subfloor 62 and the hard flooring layer 60. As previously stated, the underlayment 50 may be installed with either the moisture barrier side facing up or the moisture barrier side facing down. In FIG. 2, the underlayment 50 is installed with the moisture barrier side facing down. The embodiment of the underlayment 50 in FIG. 2 contains the flap 56, discussed previously. The flap of the right-most piece of underlayment 50, which is covered by the left-most piece of underlayment 50, is indicated by the dashed line in FIG. 2. When installing a piece of the underlayment 50, the installer places the piece of underlayment 50 directly adjacent to the existing underlayment 50. If the underlayment 50 contains a flap 56, the new piece of underlayment 50 is placed on top of the flap 56 of the existing piece of underlayment 50. The pieces of underlayment 50 are secured in place with a piece of tape 58. After the underlayment 50 has been installed, the hard flooring layer 60 is installed on top of the underlayment 50. The long seams of the hard flooring layer 60 may run parallel, perpendicular, diagonally, or any other orientation with respect to the long seams of the underlayment 50.

In an alternative embodiment of the installation process, an additional piece of moisture barrier (not shown) may be installed under the outside edge of the underlayment 50 where the subfloor 62 meets the walls 63, such that the additional piece of moisture barrier is simultaneously under the horizontal underlayment 50 and extends up the walls 63 of the room (i.e. in the vertical plane). If the underlayment 50 is configured with the flap 56, the flap 56 can be used as the additional piece of moisture barrier by simply bending the flap 56 so that the flap 56 is vertically oriented against the wall 63. The additional piece of moisture barrier adjacent to the walls 63 may be concealed using trim (not shown) after the hard flooring layer 60 has been installed over the underlayment 50. This embodiment allows the moisture barrier 54 to partially extend up the walls 63 of the room, thereby protecting the edges of the hard flooring 60 from moisture.

As yet another alternative embodiment of the present invention, the underlayment 50 can be attached to the underside of the hard flooring layer 60 as illustrated in FIG. 3. Attaching the underlayment 50 to the bottom of the hard flooring layer 60 is preferable because it combines the separate steps of installing the underlayment and installing the hard flooring layer 60 on top of the underlayment 50. By utilizing the embodiment illustrated in FIG. 3, the user can install the underlayment 50 and the hard flooring layer 60 in substantially less time than separately installing the underlayment 50 and the hard flooring layer 60. If desired, the embodiment shown in FIG. 3 may be configured with a piece of tape or moisture barrier (similar to flap 56 in FIG. 2) that extends past the edge of the underlayment 50. The piece of tape or moisture barrier is utilized much the same way as flap 56 in FIG. 2 to create a more secure moisture barrier seal at the seam where two pieces of underlayment 50 are installed next to each other.

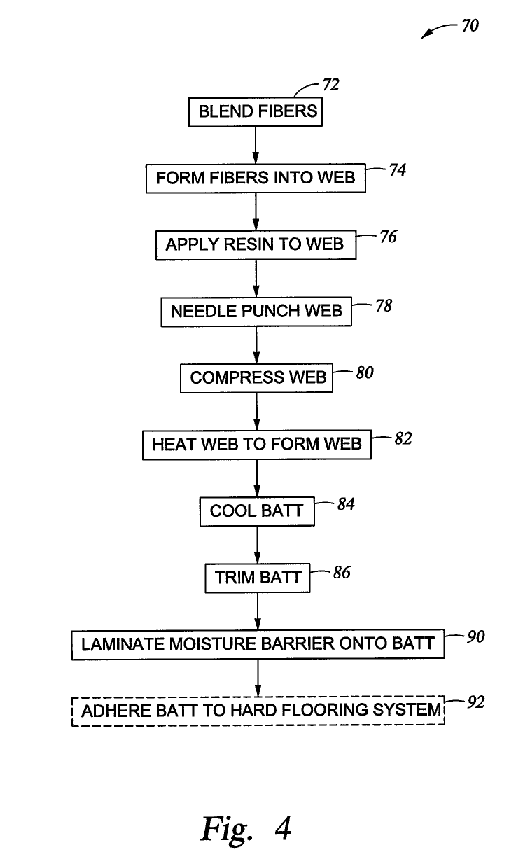

One method for making the Recycled Energy Absorbing Underlayment and Moisture Barrier for Hard Flooring System will now be described in greater detail. As seen in FIG. 4, the method for making the nonwoven fiber bait embodiment of the Recycled Energy Absorbing Underlayment and Moisture Barrier for Hard Flooring System 70 generally comprises: blending the fibers 72, forming the fibers into a web 74, coating the web with a resin 76, needle punching the web 78, compressing the web 80, heating the web to form a batt 82, cooling the batt 84, trimming the batt 86, and laminating the moisture barrier onto the batt 90. If it is desirable to attach the underlayment 50 to the hard flooring layer 60 as seen in FIG. 3, then the method 70 further comprises the step of adhering or otherwise laminating the underlayment onto the hard flooring layer 92. Each of these steps is described in greater detail below.

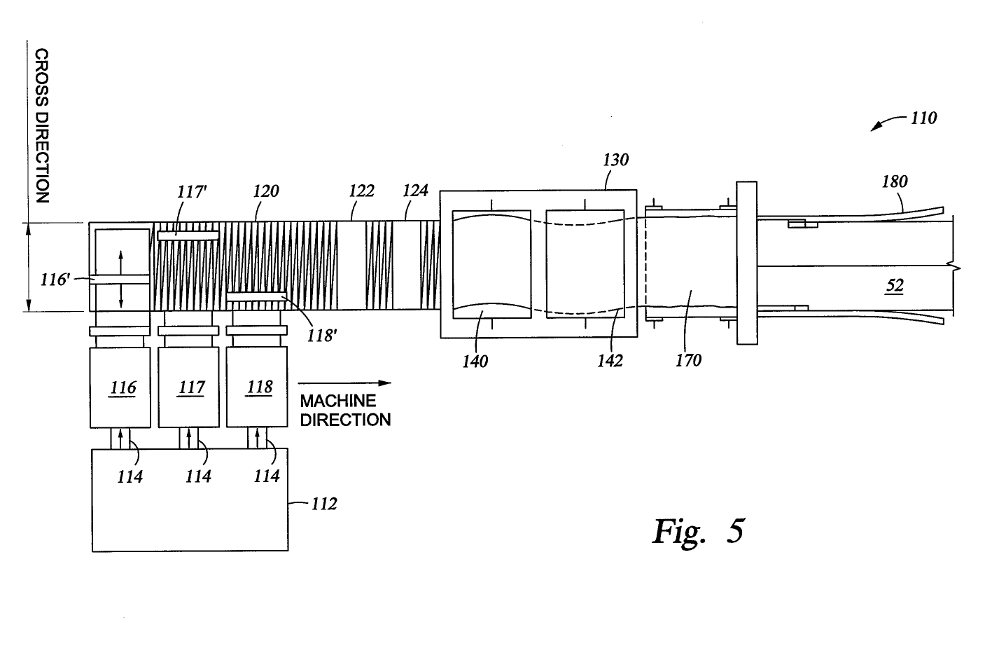

Referring now to FIG. 5, a schematic top plan view of the general processing line 110 for constructing an underlayment in accordance with the teachings of the present invention will now be described in greater detail. The general processing line performs 72 through 86 in method 70. As may now be seen, the recycled fibers are blended together per 72 in method 70 in a fiber blender 112 and conveyed by conveyor pipes 114 to a web forming machine or, in this example, three machines 116, 117, and 118. The recycled fibers are preferably shoddy fibers, but may be recycled natural fibers such as cotton or wool, recycled synthetic fibers such as polyester or polypropylene, or a mixture of recycled natural and synthetic fibers. A suitable web forming apparatus is a garnett machine. An air laying machine, known in the trade as a Rando webber, or any other suitable apparatus can also be used to form a web structure. Garnett machines 116, 117, and 118 card the blended fibers into a web per 74 in method 70, the web having a desired width and delivers the web to a cross lapper, or in this example three cross-lappers 116′, 117′, and 118′ to cross-lap the web onto a slat conveyor 120 which is moving in the machine direction. Cross-lappers 116′, 117′, and 118′ reciprocate back and forth in the cross direction from one side of conveyor 120 to the other side to form the web having multiple thicknesses in a progressive overlapping relationship. The number of layers that make up the web is determined by the speed of the conveyor 120 in relation to the speed at which successive layers of the web are layered on top of each other and the number of cross-lappers 116′, 117′, and 118′. Thus, the number of single layers which make up the web can be increased by slowing the relative speed of the conveyor 120 in relation to the speed at which cross layers are layered, by increasing the number of cross-lappers 116′, 117′, and 118′, or both. Conversely, a fewer number of single layers can be achieved by increasing the relative speed of conveyor 120 to the speed of laying the cross layers, by decreasing the number of cross-lappers 116′, 117′, and 118′, or both. In the present invention, the number of single layers which make up the web of fibers varies depending on the desired characteristics of the underlayment of the present invention. As a result, the relative speed of the conveyor 120 to the speed at which cross layers are layered and the number of cross-lappers 116′, 117′, and 118′ for forming the web may vary accordingly.

A heat curable resin is then applied to the web by resin applicator 122 per 76 in method 70. While there are a variety of techniques suitable for applying resins onto the web, generally liquid resin is sprayed onto the web or froth resin is extruded onto the web. Resins suitable for the present invention are curable by heat and can be any of a variety of compositions. Generally, the resin is comprised of polyvinyl acetate, but may also be a polymeric composition such as vinylidene chloride copolymer, latex, acrylic, or any other chemical compound. An example of a suitable resin is the SARAN 506 resin sold by the Dow Chemical Company. Additionally, the resin can contain antimicrobial, antifungal, or hydrophobic additives that further enhance the properties of the energy absorbing layer 52.

Further describing the application of liquid resin, as the web moves along a conveyor in the machine direction, the resin is sprayed onto the web from one or more spray heads that move in a transverse or cross direction to substantially coat the web. Alternatively, froth resin can be extruded onto the web using a knife or other means. The web can also be fed through or dipped into a resin bath. The applied resin is crushed into the web for saturation therethrough by nip rollers disposed along the transverse direction of the conveyor to apply pressure to the surface of the batt. Alternatively, the resin is crushed into the web by vacuum pressure applied through the batt.

The web then moves to a needle loom 124 where the web is needle-punched per 78 in method 70 to increase the density of the web. The needle loom is a device that bonds a nonwoven web by mechanically entangling the fibers within the web. The needle loom contains a needle board that contains a plurality of downwardly-facing barbed needles arranged in a non-aligned pattern. The barbs on the needles are arranged such that they capture fibers when the needle is pressed into the web, but do not capture any fibers when the needle is removed from the web. A variety of suitable needles are offered by the Foster Needle Company, Incorporated. The use of the needle loom in the present invention provides mechanical compression of the web prior to vacuum and/or mechanical compression along with the heating that occurs in housing 130. It is within the scope of the invention to forego the needle punching described herein if adequate compression can be obtained by vacuum and/or mechanical compression. Likewise, it is within the scope of the invention to forego the vaunt and/or mechanical compression if adequate compression can be obtained by needle punching.

The conveyor 120 then transports the web to housing 130 for mechanical and/or vacuum compression per 80 of method 70 and heating per 82 of method 70. While there are a variety of resin bonding methods which are suitable for the purposes contemplated herein, one such method comprises using vacuum pressure applied through perforations (not shown) in first and second counter rotating drums 140 and 142 positioned in a central portion of the housing 130. The first and second counter rotating drums 140 and 142 heat the web to the extent necessary to cure the resin in the web, typically 225-275° F. for three to five minutes. Alternatively, the web may instead move through an oven by substantially parallel perforated or mesh wire aprons that mechanically compress the batt and simultaneously cure the resin.

As the web exits the housing 130, the web is compressed and cooled per 84 in method 70 by a pair of substantially parallel wire mesh aprons 170, only one of which is visible in FIG. 5. The aprons 170 are mounted for parallel movement relative to each other to facilitate adjustment for a wide range of web thicknesses. The web can be cooled slowly through exposure to ambient temperature air or, in the alternative, ambient temperature air can be forced through the perforations of one apron 170, through the web and through the perforations of the other apron 170 to cool the web and set it in its compressed state. The web is maintained in its compressed form upon cooling since the solidification of the resin bonds the fibers together in that state.

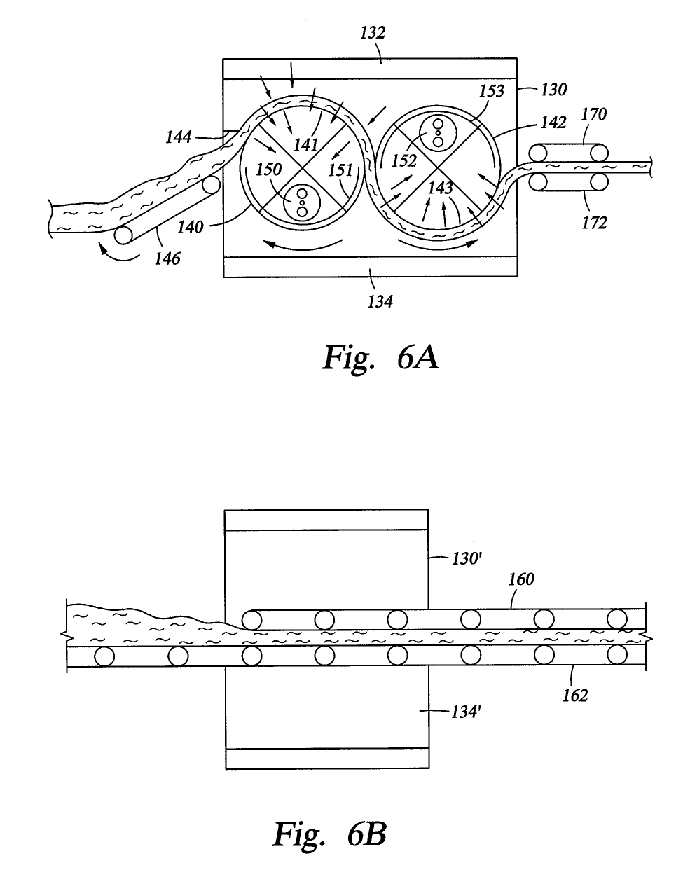

While there are a variety of resin bonding methods which are suitable for the present invention, one such method, illustrated in FIG. 6A, comprises holding the web by vacuum pressure applied through perforations of first and second counter-rotating drums and heating the web so that the resin in the batt cures to the extent necessary to fuse together the fibers in the web. Alternatively, the web moves through an oven by substantially parallel perforated or mesh wire aprons to cure the resin.

As may be seen in FIG. 6A, the aforementioned vacuum pressure method may be implemented using counter-rotating drums 140, 142 having perforations 141, 143, respectively, which are positioned in a central portion of a housing 130. The housing 130 also comprises an air circulation chamber 132 and a furnace 134 in an upper portion and a lower portion, respectively, thereof. The drum 140 is positioned adjacent an inlet 144 though which the web is fed. The web is delivered from the blending and web-forming processes described herein by means of an infeed apron 146. A suction fan 150 is positioned in communication with the interior of the drum 140. The lower portion of the circumference of the drum 140 is shielded by a baffle 151 positioned inside the drum 140 such that the suction-creating air flow is forced to enter the drum 140 through the perforations 141, which are proximate the upper portion of the drum 140, as the drum 140 rotates.

The drum 142 is downstream from the drum 140 in the housing 130. The drums 140, 142 can be mounted for lateral sliding movement relative to one another to facilitate adjustment for a wide range of batt thicknesses (not shown). The drum 142 includes a suction fan 152 that is positioned in communication with the interior of the drum 142. The upper portion of the circumference of the drum 142 is shielded by a baffle 153 positioned inside the drum 142 so that the suction-creating air flow is forced to enter the drum 142 through the perforations 143, which are proximate the lower portion of drum 142, as the drum 142 rotates.

The nonwoven web is held in vacuum pressure as it moves from the upper portion of the rotating drum 140 to the lower portion of the counter otating drum 142. The furnace 134 heats the air in the housing 130 as it flows from the perforations 141, 143 to the interior of the drums 140, 142, respectively, to cure the resin in the web to the extent necessary to bind together the fibers in the web.

Referring to FIG. 6B, in an alternative resin bonding process, the web enters housing 130′ by a pair of substantially parallel perforated or mesh wire aprons 160, 162. The housing 130′ comprises an oven 134′ that heats the web to cure the resin to the extent necessary to bind the fibers in the web together.

Collectively referring back to FIGS. 4, 5, 6A and 6B, the web is compressed and cooled per 84 of method 70 as it exits from the housing 130 or 130′ by a pair of substantially parallel first and second perforated or wire mesh aprons 170 and 172. The aprons 170 and 172 are mounted for parallel movement relative to each other to facilitate adjustment for a wide range of web thicknesses (not shown). The web can be cooled slowly through exposure to ambient temperature air or, alternatively, ambient temperature air can be forced through the perforations of one apron, through the web and through the perforations of the other apron to cool the web and set it in its compressed state. The web is maintained in its compressed form upon cooling since the resin bonds the fibers together in the compressed state. The cooled web (which, after completion of the bonding, compression and cooling, is referred to as a batt) moves into cutting zone 180 where the lateral edges of the batt are trimmed per 86 to a finished width. The batt is then cut transversely to a desired length.

It is contemplated that thermal bonding may be used to bond the batt together in lieu of the resin bonding method described herein. Thermal bonding uses low-melt binder fibers to bind the fibers together. Low-melt binding fibers do not actually melt as the term is generally understood; instead, the low-melt binder fibers become sticky or tacky when heated to a certain temperature. If the fiber batt is to be thermally bonded, the low-melt binder fibers are blended with the recycled fibers to make a homogeneous fiber blend of recycled fibers and low-melt binder fibers. The fiber blend is then carded into a web as described above. It is not necessary to apply a resin to the web if the web is to be thermally bonded although in many instances it may be desirable to do so to obtain the advantageous features of the resin described below. The web is then needle punched, if a compression is desired prior to simultaneous heat and compression. The web is then sent to a compression and heating apparatus, such as those illustrated in FIGS. 6A and 6B, where the heat melts the low-melt binder fibers. The bat is then cooled and trimmed in the same way that the resin embodiment of the batt was cooled and trimmed.

In the thermal bonded embodiment, the fiber batt is preferably formed from a homogeneous blend of binder fibers and recycled fibers. The binder fibers can be either natural or synthetic fibers. The binder fibers may also be mono-component binder fibers or bi-component binder fibers. While the homogeneous mixture of recycled fibers and binder fibers can be any of a number of suitable fiber blends, for purposes of illustrating the process and the blend, the mixture is comprised of binder finders in an amount sufficient for binding the fibers of the blend together upon application of heat at the appropriate temperature to melt the binder fibers. In one example, the binder fibers are in the range of about 5 percent to about 95 percent by total volume of the blend. Preferably, the binder finders are present in the range of about 10 percent to about 15 percent for a high-loft batt and in the range of about 15 percent to about 40 percent for a densified batt, as those characteristics are discussed below. The recycled fibers in the remaining blend volume ranges anywhere from about 5 percent to about 95 percent. Preferably, the recycled finders are present in the range of about 85 percent to about 90 percent for a high-loft batt and in the range of about 60 percent to about 85 percent for a densified batt, as those characteristics are discussed below. Blends having other percentages of hinder fibers and recycled fibers are also within the scope of the invention.

The weight per unit length of the binder fibers is also a consideration. While coarse binder fibers, e.g. those binder fibers having a weight per unit length of at least about 5 denier, are suitable for the purposes described herein, preferably the binder fibers are fine binder fibers. It is believed that a batt made of the fine binder fibers contains less porosity due to their ability to fill smaller void spaces within the binder fiber batt. By filling more of the void spaces than the coarse binder fibers, the fine binder fibers give the binder fiber batt better acoustical properties than the binder fiber ban having the coarse binder fibers. In various embodiments, the weight per unit length of the binder fibers in the binder fiber batt is at most about 5 denier, at most about 3 denier, or at most about 1 denier.

It is also contemplated that mechanical bonding may be used to bond the batt together in lieu of the resin bonding or thermal bonding methods described herein. Mechanical bonding is the process of bonding the nonwoven batt together without the use of resins, adhesives, or heat. Examples of mechanical bonding methods are needle punching, hydro entanglement, and clustering. Needle punching is the previously described method of entangling fibers using barbed needles. Hydro entanglement uses streams of high pressure water to entangle the fibers of the nonwoven web. Clustering is the mechanical entanglement of fibers during the batt forming process. Clustering frequently uses crimped fibers or fibers that otherwise have a complex shape. It is also contemplated that the fiber batt may be manufactured using different combinations of resin bonding, mechanical bonding, and/or thermal bonding.

The use of resin in the bat is advantageous for many reasons. First, resin-bonded batts are less porous than mechanically bonded or thermally bonded batts. More specifically, the resin is able to permeate through the batt more thoroughly and effectively than fibers, such as recycled fibers or binder fibers, due to its liquid form. The decreased porosity makes the fiber batt less water permeable, gives the batt better acoustical insulating properties, and makes it easier to attach various items, such as the moisture barrier or a floor covering, to the surface of the batt. In fact, depending on the specific level of water and/or vapor permeability sought, it is possible to eliminate the need for the moisture barrier by applying a sufficient amount to resin to the fiber batt.

In the embodiment utilizing a nonwoven fiber bat as the energy absorbing layer 52, the basis weight, density, and thickness of the underlayment are determined by, among other factors, the process of compressing the batt as it is cooled. The ratio of batt density to batt thickness generally dictates whether the underlayment is a high loft batt or a densified batt. For purposes herein, a densified energy absorbing layer has a ratio of basis weight (in ounces) per square foot to thickness (in inches) greater than approximately 2 to 1. Thus, a densified underlayment would have a density greater than approximately 1.5 pounds per cubic foot (pcf). Conversely, an underlayment having a ratio of basis weight to thickness of less than approximately 2 to 1 and a density less than 1.5 pcf are defined herein as high loft batts.

The expected amount of handling prior to installation should be a consideration when selecting the density of the fiber batt. Denser fiber bats provide better acoustical properties than less dense fiber batts. The acoustical properties of the fiber batt are important because a person of ordinary skill in the art will generally want the fiber batt to attenuate as much sound as possible. However, denser fiber batts are also less flexible than less dense fiber batts. Flexibility is important because a preferred feature of the fiber batt is the ability to be rolled up for storage, transportation, handling, and installation. Thus, when selecting the density of the fiber ban, a person of ordinary skill in the art must balance the need for acoustical performance with the need for flexibility. In various embodiments, a suitable balance for the density of the fiber batt is between about 1 pcf and about 10 pcf, between about 2 pcf and about 7 pcf, or between about 3 pcf and about 5 pcf.

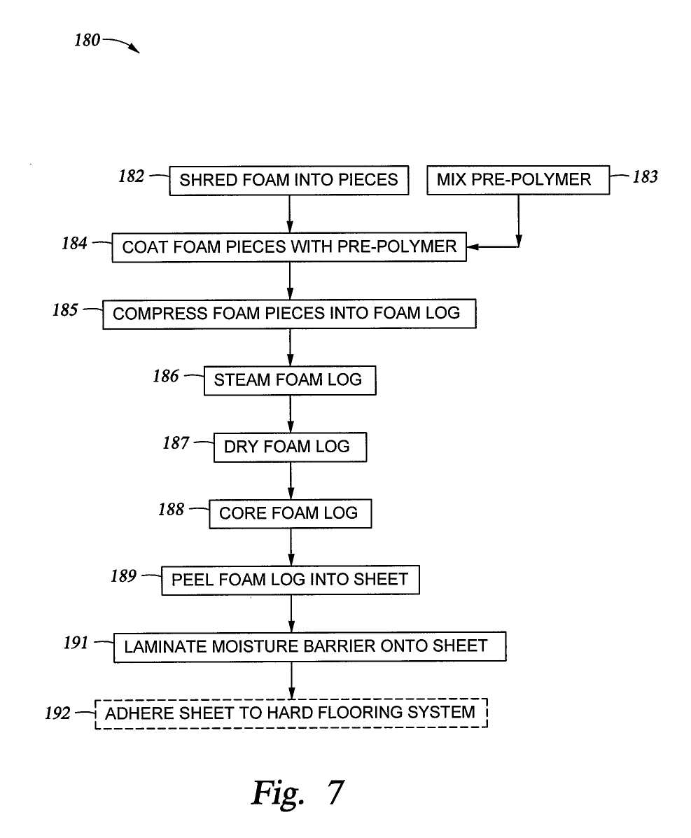

FIG. 7 depicts a block diagram of the major steps comprising one embodiment of a method 180 for making a bonded floor covering underlayment. The method 180 comprises: shredding foam into foam pieces 182, separately mixing a pre-polymer 183, coating the foam pieces with the pre-polymer 184, compressing the foam pieces into a foam log 185, steaming the foam log 186, drying the foam log 187, coring the foam log 188, peeling the foam log 189 into sheets, and laminating the moisture barrier onto the sheets 191. If desired, the sheets may then be adhered or otherwise attached to the hard flooring layer. Each of these steps is described in greater detail below.

Utilizing the bonded foam embodiment, the Recycled Energy Absorbing Underlayment and Moisture Barrier for Hard Flooring System begins with foam, which is generally scrap foam trimmings from a prime foam manufacturer. However, the foam may also be new foam or recycled foam. The size and shape of the foam is not important because the foam is shredded into a plurality of smaller foam pieces. The foam may be polyurethane, latex, polyvinyl chloride (PVC), or any other polymeric foam of any density. The foam is generally free of moisture. The foam may contain an incidental amount of impurities, such as felt, fabric, fibers, leather, hair, metal, wood, plastic, and so forth. The Recycled Energy Absorbing Underlayment and Moisture Barrier for Hard Flooring System includes other foam compositions and should not be limited to the foam compositions disclosed herein. Preferably, the foam is polyurethane foam with a density similar to the desired density of the subsequently produced underlayment. If desired, the foam may be sorted by type and/or density prior to shredding such that foam pieces of similar composition and density are used to make a single foam log. Using foam of similar composition and density to make a single foam log produces a more uniform density throughout the foam log, and thus throughout the subsequently produced underlayment.

Once the foam for the foam log has been selected, the foam is placed in a shredding machine for shredding per 182 in method 180. A shredding machine is a machine with a plurality of blades that cut the foam into smaller pieces of foam. The shredding machine resembles a household blender. The amount of time that the foam spends in the shredding machine determines the size of the shredded pieces of foam. The shredding machine may operate as either a batch or a continuous process. An example of a suitable shredding machine is the foam shredder manufactured by the Ormont Corporation of Paramus, N.J. The foam pieces may be a geometric shape, such as round or cubic, but are generally an irregular shape due to the shredding process. The shape of the smaller foam pieces is generally not important because the foam will conform to the shape of the mold. The size of the foam pieces should be such that they are large enough to be easily handled, yet small enough such that there is not an abundance of empty space between the foam particles. Preferably, the foam pieces are from about ¼-inch to about ¾-inch in each of length, width, and height dimensions.

While the foam is being shredded by the shredding machine, a pre-polymer is mixed in a separate process per 183 in method 180. One of the chemical compounds in the pre-polymer is isocyanate. The isocyanate reacts with the polyol (discussed below) and moisture in the steam (see 186 in method 180) to bind the pieces of foam together. The isocyanate used in the Recycled Energy Absorbing Underlayment and Moisture Barrier for Hard Flooring System may be any type of isocyanate, such as toluene diisocyanate (TDI), diisocyanatodiphenyl methane (MDI), or blends thereof. Examples of suitable isocyanates include: m-phenylene diisocyanate, p-phenylene diisocyanate, polymethylene polyphenyl-isocyanate, 2,4-toluene diisocyanate, 2,6-toluene diisocyanate, 4,4-diisocyanatodiphenyl methane, dianisidine diisocyanate, bi olylene diisocyanate, naphthalene-1,4-diisocyanate, diphenylene-4,4′-diisocyanate, xylylene-1,4-diisocyanate, xylylene-1,2-diisocyanate, xylylene-1,3-diisocyanate, bis(4-isocyanatophenyl)-methane, bis(3-methyl-4-isocyanatophenyl)-methane, 4,4-diphenylpropane diisocyanate, isophorone diisocyanate, hexamethylene diisocyanate, methylene-bis-cyclohexylisocyanate, and mixtures thereof. The Recycled Energy Absorbing Underlayment and Moisture Barrier for Hard Flooring System includes other isocyanates and should not be limited to the isocyanates disclosed herein. The preferred isocyanates are RUBINATE® 9041 MDI, available from the Huntsman Corporation of Salt Lake City, Utah, or POLYMERIC MDI 199, available from the Dow Chemical Corporation of Midland, Mich. The isocyanate comprises between about 10 weight percent (percent) and about 90 percent of the total pre-polymer mixture, preferably between about 20 percent and about 50 percent of the total pre-polymer mixture. Most preferably, the isocyanate comprises between about 25 percent and about 40 percent of the total pre-polymer mixture.

Another chemical compound in the pre-polymer is polyol. The polyol used in the Recycled Energy Absorbing Underlayment and Moisture Barrier for Hard Flooring System may be any type of polyol, such as diol, triol, tetrol, polyol, or blends thereof. Examples of suitable polyols include: ethylene glycol, propylene glycol, butylene glycol, hexanediol, octanediol, neopentyl glycol, 1,4-bishydroxymethyl cyclohexane, 2-methyl-1,3-propane diol, glycerin, trimethylolethane, hexanetriol, butanetriol, quinol, polyester, methyl glucoside, triethyleneglycol, tetraethylene glycol, polyethylene glycol, dipropylene glycol, polypropylene glycol, diethylene glycol, glycerol, pentaerythritol, trimethylolpropane, sorbitol, mannitol, dibutylene glycol, polybutylene glycol, alkylene glycol, oxyalkylene glycol, ethylene glycol, diethylene glycol, dipropylene glycol, triethylene glycol, tripropylene glycol, tetraethylene glycol, tetrapropylene glycol, trimethylene glycol, tetramethylene glycol, 1,4-cyclohexanedimethanol (1,4-bis-hydroxy thylcyclohexane), and mixtures thereof. The Recycled Energy Absorbing Underlayment and Moisture Barrier for Hard Flooring System includes other polyols and should not be limited to the polyols disclosed herein. The preferred polyol is VORANOL® 3512A, available from the Dow Chemical Corporation of Midland, Mich. The polyol comprises between about 10 percent and about 90 percent of the total pre-polymer mixture, preferably between about 20 percent and about 50 percent of the total pre-polymer mixture. Most preferably, the polyol comprises between about 25 percent and about 40 percent of the total pre-polymer mixture such that the polyol and isocyanate are present in the pre-polymer in approximately equal amounts.

Another chemical compound in the pre-polymer is oil. The oil lowers the overall viscosity of the pre-polymer solution to facilitate better mixing and distribution of the components. The lowered pre-polymer viscosity also allows the pre-polymer to uniformly coat the foam pieces so that improved bonding occurs. The oil may be any aromatic or non-aromatic, natural or synthetic oil. Examples of suitable oils include: naphthenic oil, soybean oil, vegetable oil, almond oil, castor oil, mineral oil, oiticica oil, anthracene oil, pine oil, synthetic oil, and mixtures thereof. The Recycled Energy Absorbing Underlayment and Moisture Barrier for Hard Flooring System includes other oils and should not be limited to the oils disclosed herein. The preferred oil is VIPLEX® 222, available from the Crowley Chemical Company of New York, N.Y. The oil comprises between about 10 percent and about 90 percent of the total pre-polymer mixture, preferably between about 20 percent and about 50 percent of the total pre-polymer mixture. Most preferably, the oil comprises between about 25 percent and about 40 percent of the total pre-polymer mixture such that the oil, polyol, and isocyanate are present in the pre-polymer in approximately equal amounts.

The pre-polymer may also contain a number of other additives to improve the characteristics of the bonded foam. For example, the pre-polymer may contain a flame retardant chemical compound, such as melamine, expandable graphite or dibromoneopentyl glycol, which improves the flame retardant properties of the bonded foam. The pre-polymer may also contain an antimicrobial additive, such as zinc pyrithione, that improves the antimicrobial properties of the bonded foam, as discussed in the aforementioned patent application. The pre-polymer may also include an antioxidant, such as butylated hydroxy toluene, that improve the resistance of the foam to oxidative-type reactions, such as scorch resulting from high exothermic temperatures. The pre-polymer may also contain colored dye, such as blue, green, yellow, orange, red, purple, brown, black, white, or gray, to distinguish certain bonded foam products from other bonded foam products. The Recycled Energy Absorbing Underlayment and Moisture Barrier for Hard Flooring System includes other additives and should not be limited to the additives disclosed herein.

The pre-polymer ingredients are combined and mixed in a mixer per 183 in method 180. The mixer may be a dynamic mixer or a static mixer. The mixer may be a batch or a continuous process mixer. Preferably, the mixer is a tank containing a motorized paddle-type mixing blade. However, the Recycled Energy Absorbing Underlayment and Moisture Barrier for Hard Flooring System includes other types of mixers and should not be limited to the mixers disclosed herein. The pre-polymer ingredients may be combined all at once, or they may be added one at a time to the pre-polymer as it is being mixed. Preferably, the pre-polymer is mixed until there are about 10 percent free isocyanates available for reacting with the steam during the steaming process. The mixed pre-polymer has a viscosity between about 100 and 1,000 centipoises, preferably between about 400 and 600 centipoises at a temperature between about 100° F. and about 110° F. Although the time varies depending on the composition of the pre-polymer, the pre-polymer is mixed for at least about 1 hour prior to application of the pre-polymer to the foam pieces. Preferably, the isocyanate, the polyol, and the oil are mixed together for at least about 4 hours, and then the amine catalyst is added to the other pre-polymer ingredients and mixed for at least about an additional two hours.

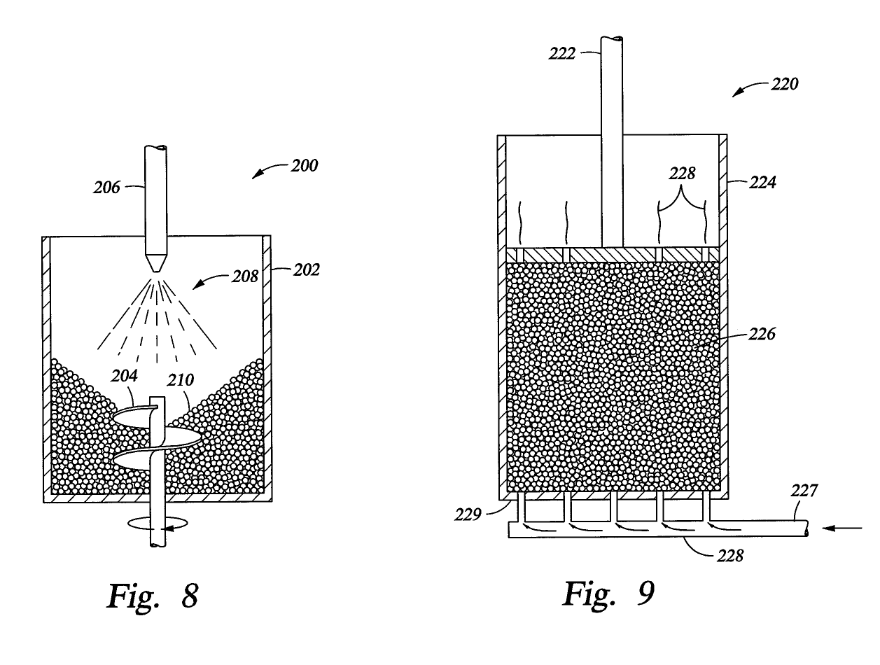

After the pre-polymer components (isocyante, polyol, oil, and any additives) have been suitably mixed, the pre-polymer is coated onto the foam pieces per 184 in method 180. The coating machine may be a batch or a continuous coating machine. FIG. 8 is an illustration of a suitable coating machine 200. The coating machine 200 comprises a tank 202, an agitator 204, and a pre-polymer applicator 206. The size and shape of the tank 202 may be varied to suit the particular application. Similarly, the number and type of agitators 204 may be varied to suit the particular application. The process of coating the foam pieces 210 begins by placing the foam pieces 210 inside the tank 210. The pre-polymer applicator 206 sprays the pre-polymer 208 onto the foam pieces 210. While the pre-polymer applicator 206 is spraying the foam pieces 210, the agitator 204 rotates with respect to the tank 202 and moves the foam pieces 210 around within the tank 202. As the foam pieces 210 move around in the tank 202, the foam pieces 210 are substantially coated with the pre-polymer 208. The time required to substantially coat the foam pieces 210 with the pre-polymer 208 varies depending on the volume and density of the foam pieces 210, the size of the tank 202, and the number and type of agitators 204, but is generally between about 0.5 minutes and 15 minutes. Preferably, the coating process proceeds for between about 1 minute and about 10 minutes, most preferably between about 1.5 minutes and about 2.5 minutes. Although the pre-polymer 208 is sprayed onto the foam pieces 210 in the coating process illustrated in FIG. 8, the pre-polymer may be applied to the foam pieces by other methods, such as dipping or roller coating. The Recycled Energy Absorbing Underlayment and Moisture Barrier for Hard Flooring System includes other types of coating processes and should not be limited to the coating process disclosed herein.

After the foam pieces have been coated with the pre-polymer, the foam pieces are transferred to a mold for the compression per 185 in method 180. FIG. 9 is an illustration of a typical mold 220 used to compress the foam pieces. The mold 220 comprises a base 229, a cylindrical wall 224, a piston 222, and a steam injection system 227. The piston 222 is able to move vertically with the wall 224 such that the volume of the cylindrical cavity defined by the piston 222, the wall 224, and the base 229 can be varied. The piston 222 is also able to be removed from within the wall 224 and positioned away from the remainder of the mold 220 to facilitate easy loading of foam pieces into the cylindrical cavity defined by the base 229 and the wall 224. The foam pieces are generally weighed before they are loaded into the mold 224. After the foam pieces are loaded into the mold 220, the piston 222 compresses the foam pieces into a foam log 226. The compression ensures complete contact between the foam pieces in the foam log 226. Because the weight of the foam pieces is known and volume within the mold 220 can be varied by the piston 222, the density of the foam log 226 can be selected by compressing the foam log 226 to a specific volume. For example, if the foam pieces weigh 100 pounds and the desired density of the foam log is 4 pcf, then the piston is positioned such that the volume of the foam log is 25 cubic feet. Although a batch-type mold is illustrated in FIG. 9, the foam pieces may be compressed using other compression methods, such as the continuous extruder illustrated in FIG. 11. The Recycled Energy Absorbing Underlayment and Moisture Barrier for Hard Flooring System includes other types of compressing processes and should not be limited to the compression process disclosed herein.

Once the foam pieces are compressed into a foam log 26, the foam log 226 is steamed to cure the pre-polymer per 186 in method 180. The steam injection system 229 is connected to a steam supply (not shown) and is able to inject steam 228 through the base 229. The steam 228 passes through the foam log 226 and any excess steam exits through perforations in the piston 222. The moisture in the steam 228 cures the pre-polymer. The steam 228 may be any steam that is at least about 212° F. and a sufficient pressure to permeate the foam log 226. Preferably, the temperature of the steam is between about 220° F. and about the combustion temperature of the foam (about 1400° F.). The pressure of the steam is preferably between about 10 pounds per square inch gauge (psi) and about 100 psi. Most preferably, the temperature of the steam is between about 246° F. and about 256° F. and the pressure of the steam is between about 13 psi and 15 psi for a batch operation and between about 30 psi and about 45 psi for a continuous operation. The steaming time is dependent on the steam pressure and the density of the foam log. For a 4 pcf foam log and using the most preferred steam, the steam time is between about 0.5 minutes and about 3 minutes, preferably about 1.0 minutes and about 1.5 minutes. For an 8 pcf foam log, the steam time is between about 1.5 minutes and about 5 minutes, preferably about 2 minutes and about 3 minutes. Steam times for foam logs of other densities can be interpolated or extrapolated from these steam times and steam data. The wall 224 of the mold 220 is removable with respect to the base 229 to facilitate easy unloading of a foam log 226 after the steaming process. The Recycled Energy Absorbing Underlayment and Moisture Barrier for Hard Flooring System includes other types of steaming processes and should not be limited to the steaming process disclosed herein.

After the steaming 186 is complete, the foam log 226 is removed from the mold and allowed to dry per 187 in method 180. The required drying time is dependent on the density of the foam log 226 and the amount of moisture present in the foam log 226. Lower density foam logs 226 may be sufficiently dry to allow immediate processing. However, the foam logs 226 are generally set aside to dry for 12 to 24 hours at ambient temperature and humidity so that foam logs 226 are sufficiently dry such that the moisture in the foam log 226 does not affect any of the processing equipment downstream of the steaming 186. If desired, the drying 187 for the foam log 226 may be sped up by forcing ambient, heated, and/or dried air over or through the foam log 226. The Recycled Energy Absorbing Underlayment and Moisture Barrier for Hard Flooring System includes other drying processes and should not be limited to the drying processes disclosed herein.

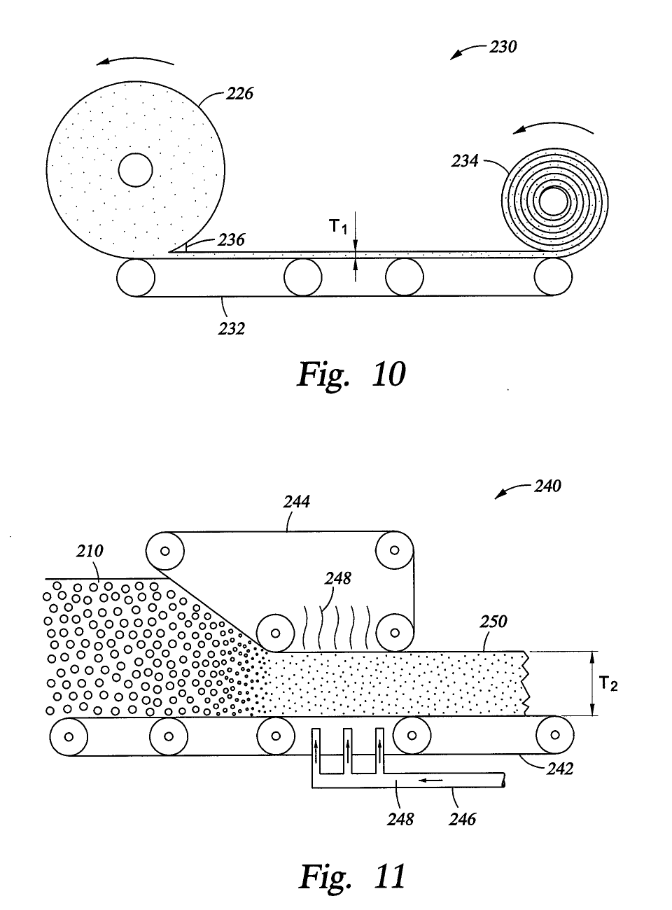

After the drying 187 is complete, the foam log 226 is cored by drilling an aperture through a center axis thereof per 188 in method 180. A rod is then inserted into the aperture, thereby enabling the foam log 226 to be handled without damaging the foam. The foam log 226 is then sent to a suitable peeling machine, such as peeling machine 230 illustrated in FIG. 10, for peeling per 189 in method 180. The peeling machine 230 comprises a blade 236, a conveyor 232, and a take-up roll 234. The foam log 226 is rotated against the blade 236 such that the blade peels off a length of a flooring underlayment 238 having a desired thickness, T₁, and formed from the bonded foam. The bonded foam peeled off of the foam log is uniformly thick and can be used as flooring underlayment 238. As the bonded foam is peeled off of the foam log 226, the foam log 226 is continuously lowered with respect to the blade 236 such that the blade 236 constantly peels off a thickness T₁ of foam from the foam log 226. In other words, as the diameter of the foam log 226 is reduced, the foam log 226 is lowered so that a uniform thickness of flooring underlayment 238 is continuously peeled off of the foam log 226. The flooring underlayment 238 may also be trimmed to a uniform width. The flooring underlayment 238 travels along the conveyor 232 and is collected on the take-up roll 234 and sent to distributors, wholesalers, and retailers. If desired, the underlayment may be cut up into shorter lengths on the take-up roll 234 so that the rolls of flooring underlayment 238 are lighter and easier to handle.

As an alternative to the batch compressing and steaming process described above, the present invention may be utilized in a continuous compressing and molding process. Fla 11 illustrates a continuous extruder 240 used for continuously compressing and steaming the foam pieces 210 into a continuous foam log 250. The continuous extruder 240 comprises an upper conveyor 244, a lower conveyor 242, and a steam injection system 246. The process of compressing and steaming the foam log 250 begins with the placement of foam pieces 210 onto the lower conveyor 242. Because the density of the foam log 250 produced by the continuous extruder 240 depends on the mass flow rate of the foam pieces 210 through the continuous extruder 40 as well as the volumetric flow rate of the foam log 250 exiting the extruder, the weight of the foam pieces 210 is typically measured prior to placing the foam pieces 210 onto the lower conveyor 242. As the foam pieces 210 travel through the continuous extruder 240, the foam pieces 210 are compressed by the upper conveyor 244. Because the upper conveyor 244 and the lower conveyor 242 travel in the same direction and the foam pieces 210 are continuously entering the continuous extruder 240, the foam pieces 210 are compressed by the downward traveling upper conveyor 244. The height of the upper conveyor 244 over the lower conveyor 242 is adjustable and the density of the foam log 250 can be adjusted by raising and lowering the upper conveyor 242 relative to the lower conveyor 242.

When the foam log is at a desired density, steam 248 is injected into the underside of the foam log 250 through perforations in the lower conveyor 242, with any excess steam passing through the perforations in the upper conveyor 244. The continuous extruder 240 is configured such that the residence time of the foam log 250 in the steaming area of the continuous extruder 240 is equal to the steaming time required in the batch process. The foam log produced by the continuous extruder 240 is generally rectangular in cross section and is thus sliced into sheets rather than peeled in the manner described above.

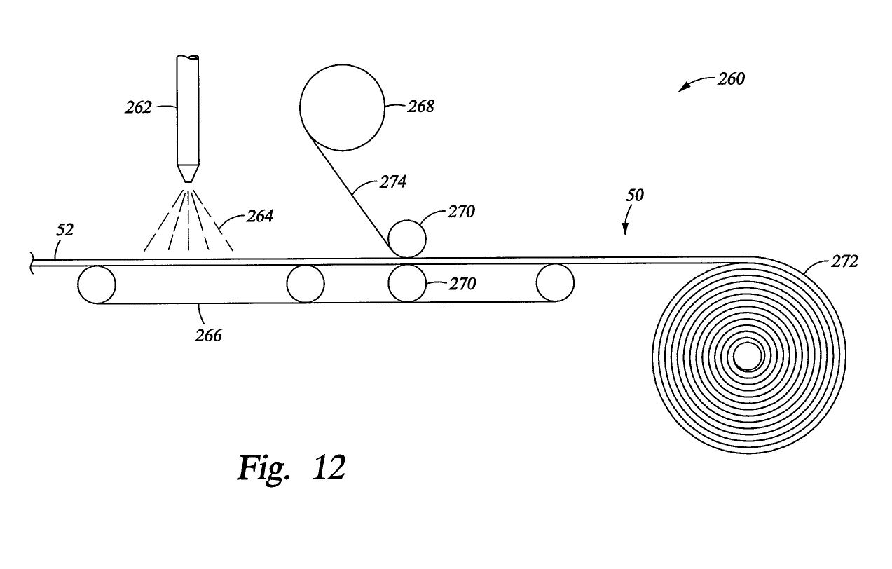

After either the nonwoven fiber batt embodiment or the bonded foam embodiment of the energy absorbing layer 52 is produced, the moisture barrier 54 is laminated onto the energy absorbing layer 52 per 90 in method 70 or 191 in method 180 to create the underlayment 50. In the case where the moisture barrier 54 is a film, FIG. 12 illustrates an apparatus 260 that laminates the film 274 onto the energy absorbing layer 52. The energy absorbing layer 52 moves across a conveyer 266 and passes under an adhesive applicator 262. The adhesive applicator 262 sprays an adhesive 264 onto the energy absorbing layer 52. Alternatively, the adhesive applicator 262 could extrude a frothed adhesive onto the energy absorbing layer 52. The moisture barrier 274 from roll 268 is layered onto the top surface of the energy absorbing layer 52. Two nip rollers 270 compress the moisture barrier 274 and the energy absorbing layer 52 together to form the underlayment 50. If the adhesive 264 needs to be cured, the underlayment 50 can pass through an oven (not shown) to cure the adhesive. The underlayment 50 is then collected on roller 272 and shipped to wholesalers, distributors, and/or retailers as needed.

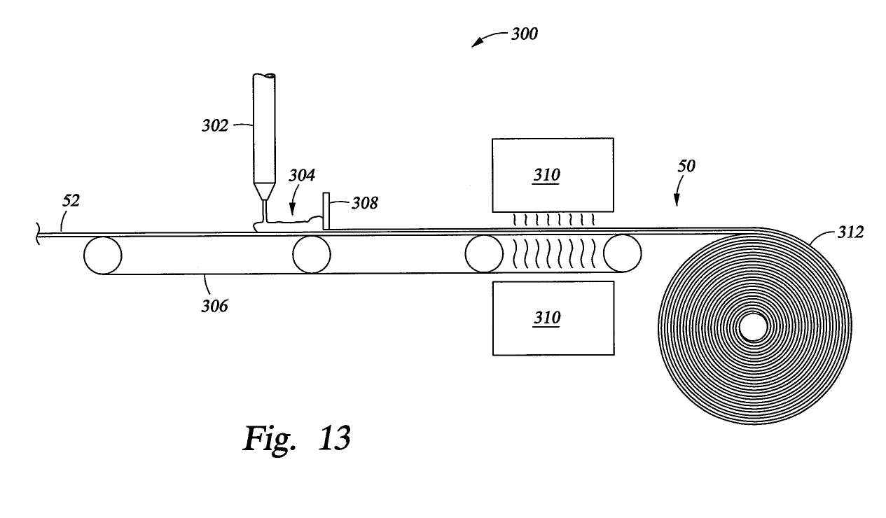

In the case where the moisture barrier is closed cell foam, FIG. 13 illustrates an apparatus 300 that laminates a layer of closed cell foam 304 onto the energy absorbing layer 52. A conveyor 306 carries the energy absorbing layer 52 underneath a foam applicator 302, which deposits foam 304 on top of the energy absorbing layer 52. Alternatively, the foam 304 may be sprayed, roller coated, or otherwise applied to the energy absorbing layer 52, or the energy absorbing layer 52 may be dipped into a vat of the foam 304. A doctor blade 308 regulates the amount of foam 304 deposited on top of the energy absorbing layer 52. The foam 304 and energy absorbing layer 52 pass through an oven 310 that cures the foam 304. The resulting underlayment 50 is collected on a roller 312 and shipped to wholesalers, distributors, and/or retailers as needed.

If the energy absorbing layer is 52 is a nonwoven fiber batt containing recycled synthetic fibers, then an alternative embodiment of the moisture barrier 54 exists. When the energy absorbing layer is 52 is a nonwoven fiber batt, the moisture barrier 54 may be created by calendering one or more surfaces of the nonwoven fiber batt. Calendering is a process by which one surface of the batt is modified by passing the batt between a set of cylindrical drums, one of which is heated. Alternatively, the batt can be placed on a smooth conveyor belt and passed through an oven. The heat from the drum or the oven melts the synthetic fibers in the batt such that they form a thin layer of material similar to a film. The calendered surface of the batt differs from a layer of film laminated onto the batt in that the batt and the calendered surface are the same material, generally polymeric material, but in fiber and sheet form. The calendered surface of the batt is generally moisture impervious, but may be vapor permeable, depending on the specific temperature and calendering apparatus used. Because the calendered surface of the batt is moisture impervious, the calendered surface of the batt acts as a moisture barrier eliminating the need for any other type of moisture barrier. Thus, calendering the surface of the batt is advantageous because it eliminates the need to laminate a moisture barrier onto the nonwoven fiber batt.

In an additional alternative embodiment, the energy absorbing layer 52 and/or the moisture barrier 54 can contain a scented or deodorizing additive. Scented and deodorizing additives are advantageous because they improve the smell of the flooring and can mask or eliminate unwanted odors. Scented and deodorizing additives are well known in the art, as evidenced by scented and deodorizing carpet cleaner. It is within the scope of the invention to include a scented or deodorizing additive in the recycled fiber blend for the nonwoven fiber batt embodiment of the energy absorbing layer 52, within the pre-polymer of the bonded foam embodiment of the energy absorbing layer 52, or within the moisture barrier 54. Alternatively, the scented or deodorizing additive can be attached to the energy absorbing layer 52, the moisture barrier 54, or both.

It is contemplated that methods other than adhesive may be used to laminate the moisture barrier 54 onto the energy absorbing layer 52. For example, some moisture barriers 54 become tacky when heated. If such a moisture barrier 54 were used, the moisture barrier 54 would be layered onto the energy absorbing layer 52 without the use of an adhesive. The energy absorbing layer 52 and moisture barrier 54 would then be heated to make the moisture barrier 54 tacky such that the moisture barrier 54 bonds to the energy absorbing layer 52. When the underlayment 50 cools, the moisture barrier 54 would then be attached to the energy absorbing layer 52 without the use of a separate adhesive. Alternatively, if the moisture barrier 54 and the energy absorbing layer 52 contain polymeric and/or thermoplastic materials, the moisture barrier 54 and the energy absorbing layer 52 can be integrally joined by heating the moisture barrier 54 and the energy absorbing layer 52, contacting or compressing the moisture barrier 54 and the energy absorbing layer 52 together, and then cooling the moisture barrier 54 and the energy absorbing layer 52. It is contemplated that any other bonding method that does not use an adhesive may be used to laminate the moisture barrier 54 onto the energy absorbing layer 52, thereby forming the underlayment 50.

If it is desired that the underlayment 50 be attached to the hard flooring layer 60 per 92 in method 70 or 192 in method 180, the underlayment 50 is preferably attached to hard flooring layer 60 after the moisture barrier 54 has been attached to the energy absorbing layer 52. The process of adhering the energy absorbing layer 52 onto the hard flooring layer 60 is similar to the process of adhering the moisture barrier 54 onto the energy absorbing layer 52: an adhesive (not shown) is sprayed onto the bottom side of the hard flooring layer 60 and the underlayment 50 is laminated onto the bottom side of the hard flooring layer 60. A pair of nip rollers (not shown) can ensure that the underlayment 50 completely contacts the hard flooring layer 60. As part of the process of attaching the underlayment 50 to the hard flooring layer 60, the hard flooring layer 60 can be inverted so the side that faces up during the manufacturing process will be the underside of the hard flooring layer 60 when the hard flooring layer 60 is installed. This allows gravity to hold the underlayment 50 on the hard flooring layer 60 until the adhesive takes full effect and bonds the underlayment 50 onto the hard flooring layer 60.

Another consideration for the underlayment 50 is the thickness of the energy absorbing layer 52. While thicker energy absorbing layers 52 are preferred in some applications, such as carpet underlayment 50, thinner energy absorbing layers 52 are preferred in hard flooring layer 60. An example of a energy absorbing layer 52 suitable for use as an underlayment 50 for hard flooring layer 60 has a thickness of between about 0.05 inches and about 0.25 inches, a density of between about 2 pcf and about 20 pcf, and a basis weight of between about 0.5 ounces per square foot and about 10 ounces per square foot. Preferably, the energy absorbing layer 52 has a thickness between about 0.1 inches and about 0.3 inches, a density between about 5 pcf and about 10 pcf, and a basis weight between about 1 ounce per square foot and about 4 ounces per square foot. Such an underlayment 50 typically comes in a 3 foot by 60 foot roll and has a roll weight of about 28 pounds.

There are many advantages to using the underlayment 50 over prior art underlayments. The underlayment 50 contains recycled fibers, which lowers the cost of manufacturing the underlayment 50. With lowered manufacturing costs, the manufacturer can sell the underlayment 50 to the consumer at a lower cost. The recycled materials in the underlayment 50 are also appealing to consumers who prefer recycled materials for environmental reasons. The underlayment 50 can also be attached to the bottom of hard flooring 60 so that the time and complexity of installing the underlayment 50 and the flooring is reduced. The underlayment 50 also acts a moisture barrier 54, absorbs the sound of a person walking on the underlayment 50, and smoothes irregularities in the subfloor.

While a number of preferred embodiments of the invention has been shown and described herein, modifications thereof may be made by one skilled in the art without departing from the spirit and the teachings of the invention. The embodiments described herein are exemplary only, and are not intended to be limiting. Many variations, combinations, and modifications of the invention disclosed herein are possible and are within the scope of the invention. Accordingly, the scope of protection is not limited by the description set out above, but is defined by the claims which follow, that scope including all equivalents of the subject matter of the claims.

What is claimed is:

1. A method of forming a flooring underlayment for a hard flooring system comprising the steps of:
providing a plurality of recycled textile fibers; and
forming the plurality of recycled textile fibers into a nonwoven fiber batt using at least two bonding techniques selected from the group consisting of: resin bonding, thermal bonding, and mechanical bonding.

2. The method of claim 1, wherein resin bonding results in the batt further comprising resin; thermal bonding results in the batt further comprising binder fibers, wherein the binder fibers and recycled fibers are approximately homogeneously dispersed throughout the batt; and mechanical bonding results in the fibers of the batt being entangled.

3. The method of claim 1, wherein:
the nonwoven fiber batt is formed using resin bonding and thermal bonding;
thermal bonding comprises providing a plurality of binder fibers, blending the binder fibers with the recycled textile fibers to make a homogeneous blend of recycled fibers and binder fibers, and forming the homogeneous blend of fibers into a web; and
resin bonding comprises coating the web with resin and heating the web to cure the resin.

4. The method of claim 3, wherein the binder fibers have a denier less than about 5.

5. The method of claim 1, wherein:
the nonwoven fiber batt is formed using resin bonding and mechanical bonding;
resin bonding comprises forming the recycled textile fibers into a web, coating the web with resin, and heating the web to cure the resin; and
mechanical bonding comprises needle-punching the web to entangle fibers within the web.

6. The method of claim 1, wherein forming the plurality of recycled textile fibers into a nonwoven fiber batt using at least two bonding techniques densifies the nonwoven fiber batt between about 3 pcf and about 5 pcf.

7. The method of claim 1 further comprising attaching a moisture barrier to the nonwoven fiber batt.

8. The method of claim 1, wherein the step of providing a plurality of recycled textile fibers further comprises cleaning shoddy material recycled from a manufacturing process, shredding the shoddy material to form shoddy fibers, and blending the shoddy fibers to form a homogeneous blend of recycled shoddy fibers.

9. The method of claim 1, wherein:
the nonwoven fiber batt is formed using thermal bonding and mechanical bonding;
thermal bonding comprises providing a plurality of binder fibers, blending the binder fibers with the recycled textile fibers to make a homogeneous blend of recycled fibers and binder fibers, forming the homogeneous blend of fibers into a web, and heating the web to melt the binder fibers; and
mechanical bonding comprises needle-punching the web to entangle fibers within the web.

10. A method of forming an underlayment comprising the steps of:
blending a plurality of recycled textile fibers and a plurality of binder fibers to form a fiber blend;
forming the fiber blend into a web;
needle-punching the web; and
heating the web sufficiently to melt the binder fibers, thereby forming a nonwoven fiber batt.

11. The method of claim 10 further comprising attaching a moisture barrier to the nonwoven fiber batt.

12. The method of claim 11, wherein the moisture barrier comprises a polymeric film.

13. The method of claim 10, further comprising providing a plurality of recycled textile fibers, and wherein providing a plurality of recycled textile fibers comprises cleaning shoddy material and shredding the shoddy material to form shoddy fibers.

14. The method of claim 10, wherein needle-punching the web densifies the web, and wherein the density of the resulting nonwoven fiber batt ranges from about 3 pcf to about 5 pcf.

15. The method of claim 10 further comprising coating the web with a heat-curable resin.

16. A method of forming a flooring underlayment comprising:
providing a plurality of recycled textile fibers;
forming the plurality of recycled textile fibers into a nonwoven batt using mechanical bonding and at least one additional bonding technique selected from the group consisting of: thermal bonding and resin bonding.

17. The method of claim 16, wherein the nonwoven fiber batt is formed using resin bonding in addition to mechanical bonding, resulting in a nonwoven fiber batt having resin dispersed throughout the batt and entangled fibers within the batt, and resulting in a batt having a density between about 3 pcf and about 5 pcf.

18. The method of claim 16, wherein the nonwoven fiber batt is formed using thermal bonding in addition to mechanical bonding, resulting in a batt having binder fibers approximately homogeneously dispersed throughout the batt and fibers entangled within the batt.

19. The method of claim 16 further comprising attaching a moisture barrier to the nonwoven fiber batt.

20. The method of claim 18 further comprising attaching a moisture barrier to the nonwoven fiber batt.
